(19) United States
(12) Patent Application Publication
(10) Pub. No.: US 2019/0098226 A1
(43) Pub. Date: Mar. 28, 2019

(54) SMART FIELD OF VIEW (FOV) ADJUSTMENT FOR A REARVIEW DISPLAY SYSTEM IN A MOTOR VEHICLE

(71) Applicant: Panasonic Automotive Systems Company of America, Division of Panasonic Corporation of North America, PEACHTREE CITY, GA (US)

(72) Inventors: VISHWAS D. KULKARNI, ROCHESTER HILLS, MI (US); SATOSHI SUGAWARA, WEST BLOOMFIELD, MI (US)

(73) Assignee: Panasonic Automotive Systems Company of America, Division of Panasonic Corporation of North America

(21) Appl. No.: 16/143,092

(22) Filed: Sep. 26, 2018

Related U.S. Application Data
(60) Provisional application No. 62/563,536, filed on Sep. 26, 2017.

(51) Int. Cl. H04N 5/262; B60R 1/00; H04N 7/18

(52) U.S. Cl. CPC H04N 5/2628; B60R 1/00; B60R 2300/8066; B60R 2300/30; B60R 2300/8046; H04N 7/183

(57) ABSTRACT

A rearview display arrangement for a motor vehicle includes a rearview camera positioned to capture images behind the motor vehicle. A heading direction sensor detects a heading direction of the motor vehicle. An electronic processor is communicatively coupled to the rearview camera and to the heading direction sensor. The electronic processor crops an area from the captured images dependent upon the detected heading direction of the motor vehicle. The electronic processor transmits a video signal including the area cropped from the captured images. A rearview display screen is communicatively coupled to the electronic processor and presents the video signal to a driver of the motor vehicle.

### CROSS-REFERENCE TO RELATED APPLICATION

This application claims benefit of U.S. Provisional Application No. 62/563,536 filed on Sep. 26, 2017, which the disclosure of which is hereby incorporated by reference in its entirety for all purposes.

### FIELD OF THE INVENTION

The disclosure relates to a rearview display system in a motor vehicle, which may be referred to as an interior rearview monitor system (IRMS), a full display mirror (FDM), a rear view display mirror (RVDM), or a camera monitor system (CMS).

### BACKGROUND OF THE INVENTION

A rearview display system has a camera mounted on a rear side of the vehicle facing in a rearward direction (e.g., viewing the road behind the vehicle). A display is embedded inside the rearview mirror (which is also called a “half mirror”). The camera captures the video images of the road behind the vehicle and renders the video images on the display. An advantage of this system is that the driver gets an unobstructed view in the rearward direction (e.g., eliminating the headrests, tall rear passengers and any luggage in the back). In addition, a wider view in the rearward direction is provided as compared to a traditional rearview mirror.

Camera Monitor Systems (CMS) are similar to rear view display systems except there is no mirror. Thus, they cannot be used in mirror mode. CMS systems are allowed (or being considered) by EU regulations now. There are limitations with the current rearview mirror system or traditional rearview mirror system. The image position is fixed, and what is straight behind the vehicle is displayed (as per user settings), regardless of whether the vehicle is making a turn, or is being driven on a winding road, road bends, hilly road, etc.

### SUMMARY

The present invention may enable a middle portion to be cropped from the captured rearward image, and be presented on the display. The invention may also enable dynamic control of an adjustment range of the cropped middle portion and enable the cropped middle portion of the captured rearward images to be selected or moved relative to the captured images in response to vehicle parameters such as steering angle, vehicle speed, gear information (e.g., what gear the vehicle is in), an onboard gyroscope, etc.

The inventive rearview display system may continuously receive inputs from the vehicle, such as the steering angle, vehicle speed, gear information, etc. The inventive rearview display system may calculate, based on this vehicle data, the adjustments that can be applied. The inventive rearview display system may also select an appropriate crop area from the overall captured image, based on the vehicle data, to render on the display. The image displayed as a result of these adjustments may be an image that enables the driver to view an appropriate image of the road behind the vehicle, regardless of the angle relative to the vehicle, and not merely the image of the scene straight behind the vehicle.

The driver can manually adjust the rear view for his/her choice left/right/up/down and the dynamic adjustments may also consider this initial position/preference while applying dynamic adjustments. The invention may use the adjustment range and move the cropped area (within the adjustment range) to compensate for the vehicle's dynamic position so that the driver is able to see a view of the road behind him and compensate for winding roads, road bends, turns, hilly roads, etc.

In one embodiment, the invention comprises a rearview display arrangement for a motor vehicle, including a rearview camera positioned to capture images of a scene behind the motor vehicle. A heading direction sensor detects a heading direction of the motor vehicle. An electronic processor is communicatively coupled to the rearview camera and to the heading direction sensor. The electronic processor crops an area from the captured images dependent upon the detected heading direction of the motor vehicle. The electronic processor transmits a video signal including the area cropped from the captured images. A rearview display screen is communicatively coupled to the electronic processor, receives the transmitted video signal, and presents the video signal to a driver of the motor vehicle.

In another embodiment, the invention comprises a rearview display method for a motor vehicle, including capturing images of a scene behind the motor vehicle. A heading direction of the motor vehicle is detected. An area is cropped from the captured images dependent upon the detected heading direction of the motor vehicle. A video signal including the area cropped from the captured images is transmitted. The video signal is presented to a driver of the motor vehicle on a rearview display screen.

In yet another embodiment, the invention comprises a rearview display arrangement for a motor vehicle, including a rearview camera positioned to capture images of a scene behind the motor vehicle. A plurality of heading direction sensors conjunctively detect a heading direction of the motor vehicle in three dimensions. An electronic processor is communicatively coupled to the rearview camera and to the heading direction sensors. The electronic processor selects an area to be cropped from the captured images dependent upon the detected heading direction of the motor vehicle. The electronic processor transmits a signal indicative of the area to cropped from the captured images. A rearview display screen is communicatively coupled to the electronic processor, receives the transmitted signal, and presents mirror images of the cropped captured images to a driver of the motor vehicle.

An advantage of the present invention is that it may enable the user to see the road behind him, even in scenarios involving winding roads, road bends, turns, and hilly roads.

### BRIEF DESCRIPTION OF THE DRAWINGS

A better understanding of the present invention will be had upon reference to the following description in conjunction with the accompanying drawings.

FIG. 1 is a block diagram of one example embodiment of a rearview display arrangement of the present invention for a motor vehicle.

FIG. 2 is a plan view of the cropping of the images captured by the rearview camera of FIG. 1.

FIG. 3 is a flow chart of one embodiment of a rearview display method of the present invention for a motor vehicle.

### DETAILED DESCRIPTION OF THE PREFERRED EMBODIMENTS

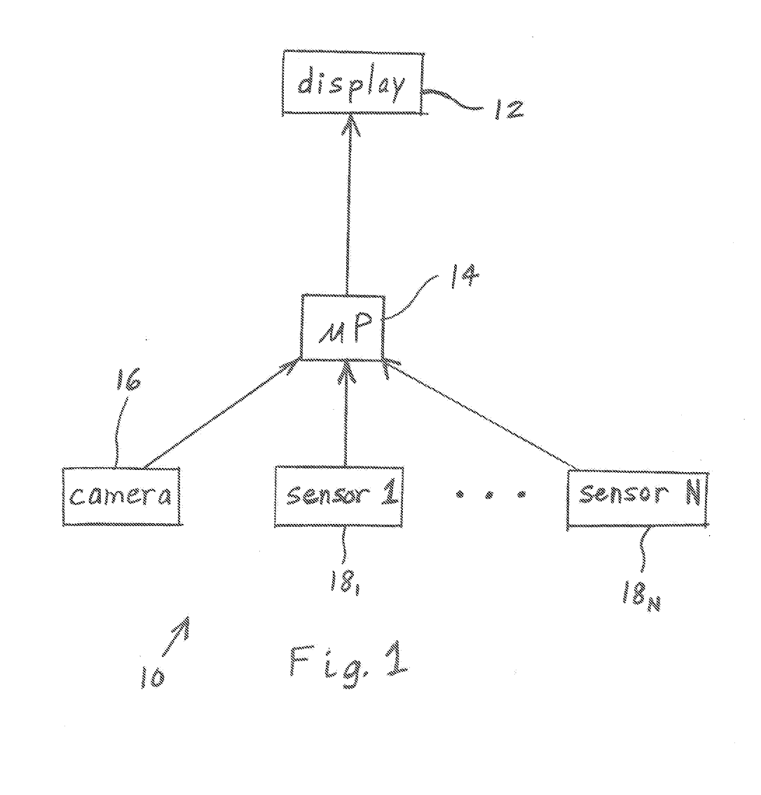

FIG. 1 illustrates one example embodiment of a rearview display arrangement 10 of the present invention for a motor vehicle. Arrangement 10 includes a rearview display 12, an electronic processor 14, a rearview camera 16, and a plurality of sensors 18₁ . . . 18_{N}. Rearview display 12 may be positioned at the same location as a traditional rearview mirror or any other location (e.g., center stack, top of instrument panel) in the passenger compartment of a motor vehicle in which arrangement 10 is disposed. Rearview camera 16 may be mounted on a back bumper of the vehicle, or at a location on the vehicle with a similarly unobstructed field of view in a rearward direction, as the rearward direction is defined by the orientation of the vehicle.

The rearview camera can be same as or different than the back up camera. It would normally be at or near center of vehicle, but could be anywhere from roof mounted (shark fin housing), inside rear windshield, number plate or bumper.

Sensors 18 may include a steering wheel angle sensor, a speedometer, a gear sensor, and/or a gyroscope, for example. Sensors 18 may detect a change in a heading direction of the vehicle, or a rate of change in the heading direction of the vehicle. The heading direction of the vehicle may be defined in terms of the vehicle being pointed at a certain point along the 360-degree horizon and/or being oriented at a certain angle up or down relative to the horizon or relative to a direction that is perpendicular to the direction of the force of gravity.

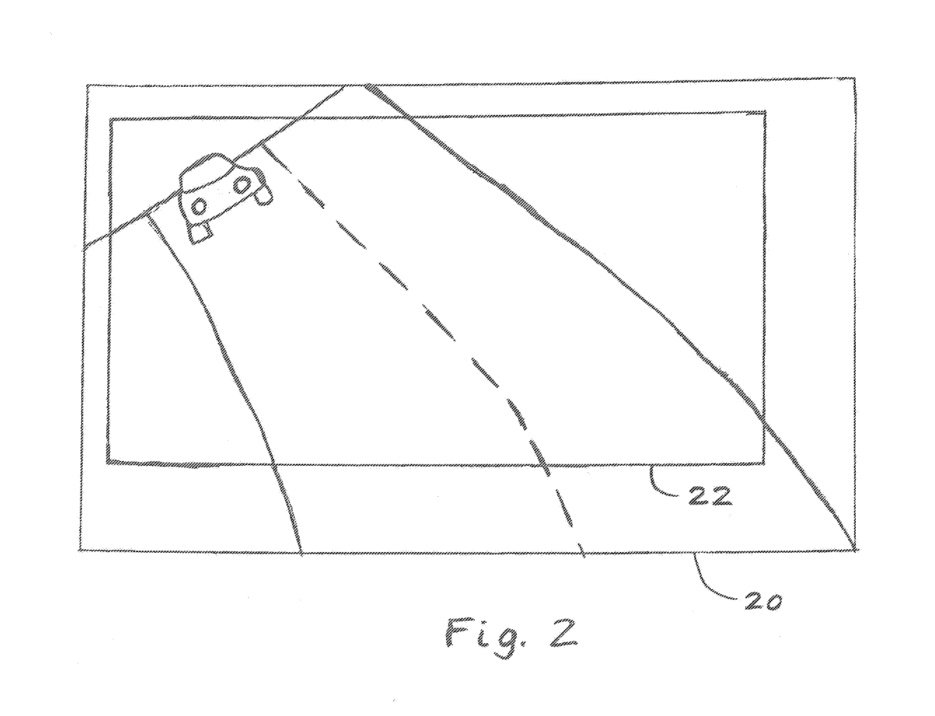

FIG. 2 illustrates the cropping of an image 20 captured by rearview camera 16 of FIG. 1. If sensors 18 determine that the road behind the vehicle is most likely in the upper left-hand corner of image 20, then a rectangular portion 22 which is offset towards the upper left-hand corner of image 20 may be cropped from image 20. For example, if sensors 18 detect that the vehicle is turning to the right and has reached the bottom of a hill, then processor 14 may determine that the road behind the vehicle is most likely in the upper left-hand corner of image 20. The amount of the offset of cropped image 22 from the center of captured image 20 toward the upper left corner may depend upon how sharply the vehicle is turning left and how steep the incline was that the vehicle has just descended down.

Cropped image 22 may be selectively positioned anywhere within captured image 20, with an offset of any distance in the left or right direction (e.g., along the x-axis), and/or in the up or down direction (e.g., along the y-axis). When the vehicle is traveling up and down hilly roads, the area of the cropping may be moved along the y-axis to compensate for, or provide, the angle needed for the driver to be able to see the horizon and the road behind the vehicle. Moving window integration may be used in order to have a smooth adjustment applied.

When travelling on a winding road, on road bends, or on turns, etc., the cropped area may be moved along the x-axis to compensate for the angle of the turns and to show the driver the road behind the vehicle. Here too, moving window integration may be used in order to have smooth adjustment applied. It is to be understood that the images presented on the display may be mirror images of the captured images relative to a vertical axis. Thus, the presented images have the same directionality as a conventional mirror image, which may make the operation of the display more intuitive to the user.

As described above with reference to FIGS. 1-2, the invention may dynamically control the adjustment range of cropped image 22 and move the displayed area (e.g., cropped area) 22 in response to changes in vehicle parameters such as steering angle, vehicle speed, gear information, onboard gyroscope outputs, etc. Thus, the invention may enable the user to see the road behind him, even if the vehicle is traveling on winding roads, road bends, turns, hilly roads, etc.

In another embodiment, the camera circuit includes a gyroscope sensor. The gyroscope sensor may detect vehicle turns. The camera may provide gyroscope data along with video data to the display's control unit. The display shall use the gyroscope information along with the vehicle data described above with reference to other embodiments to calculate the crop area.

In yet another embodiment, the camera assembly includes a gyroscope sensor as well as a control algorithm to determine an appropriate crop based on only the gyroscope data. The camera may send only this crop image to the display.

In still another embodiment, rather than a using a crop image, an electro-mechanical system may be used to aim the camera appropriately in the X-axis and the Y-axis to achieve the same result.

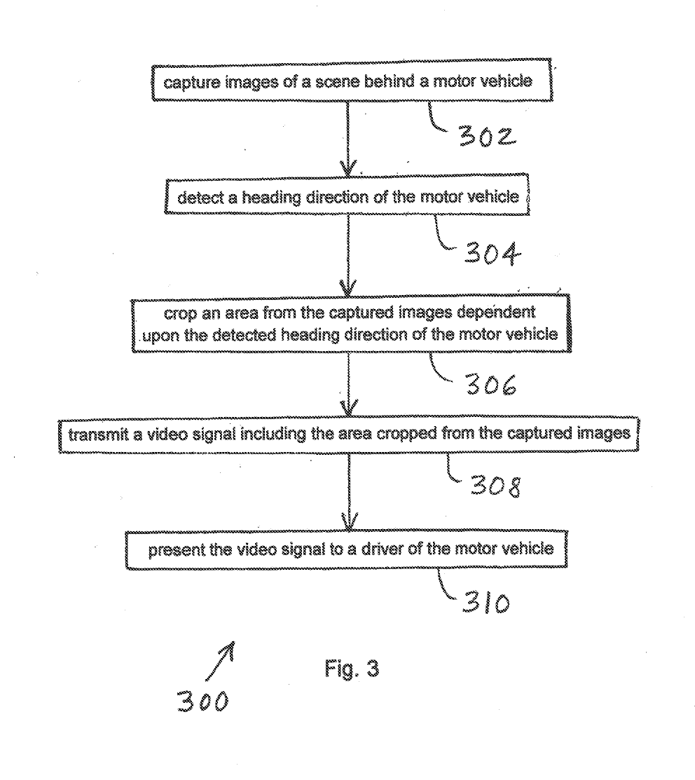

FIG. 3 illustrates one embodiment of a rearview display method of the present invention for a motor vehicle. In a first step 302, images of a scene behind the motor vehicle are captured. For example, rearview camera 16 may be mounted on the vehicle with an unobstructed field of view in a rearward direction, and may capture images in the field of view.

Next, in step 304, a heading direction of the motor vehicle is detected. For example, sensors 18 may detect a heading direction of the vehicle.

In a next step 306, an area is cropped from the captured images dependent upon the detected heading direction of the motor vehicle. For example, if sensors 18 detect that the heading direction is defined by the vehicle turning to the right and reaching the bottom of a hill, then processor 14 may determine that the road behind the vehicle is most likely in the upper left-hand corner of image 20. Then a rectangular portion 22 which is offset towards the upper left-hand corner of image 20 may be cropped from image 20.

In step 308, a video signal including the area cropped from the captured images is transmitted. For example, a video signal including the area 22 cropped from the captured images may be transmitted from processor 14 to display 12.

In a final step 310, the video signal is presented to a driver of the motor vehicle. For example, display 12 may convert the video signal into a visible image presented on a screen of display 12.

The foregoing description may refer to “motor vehicle”, “automobile”, “automotive”, or similar expressions. It is to be understood that these terms are not intended to limit the invention to any particular type of transportation vehicle. Rather, the invention may be applied to any type of transportation vehicle whether traveling by air, water, or ground, such as airplanes, boats, etc.

The foregoing detailed description is given primarily for clearness of understanding and no unnecessary limitations are to be understood therefrom for modifications can be made by those skilled in the art upon reading this disclosure and may be made without departing from the spirit of the invention.

What is claimed is:

1. A rearview display arrangement for a motor vehicle, the arrangement comprising:
a rearview camera positioned to capture images of a scene behind the motor vehicle;
a heading direction sensor configured to detect a heading direction of the motor vehicle;
an electronic processor communicatively coupled to the rearview camera and to the heading direction sensor, the electronic processor being configured to:
crop an area from the captured images dependent upon the detected heading direction of the motor vehicle; and
transmit a video signal including the area cropped from the captured images; and
a rearview display screen communicatively coupled to the electronic processor and configured to:
receive the transmitted video signal; and
present the video signal to a driver of the motor vehicle.

2. The arrangement of claim 1 wherein the heading direction sensor comprises at least one of a steering wheel angle sensor, a speedometer, a gear sensor, and/or a gyroscope.

3. The arrangement of claim 1 wherein the electronic processor is configured to crop an upwardly offset area from the captured images in response to the heading direction sensor detecting that the motor vehicle has reached a bottom of a hill.

4. The arrangement of claim 1 wherein the electronic processor is configured to crop a downwardly offset area from the captured images in response to the heading direction sensor detecting that the motor vehicle has reached a top of a hill.

5. The arrangement of claim 1 wherein the electronic processor is configured to crop a leftwardly offset area from the captured images in response to the heading direction sensor detecting that the motor vehicle is turning in a rightward direction, and the video signal is indicative of a mirror image of the area cropped from the captured images.

6. The arrangement of claim 1 wherein the electronic processor is configured to crop a rightwardly offset area from the captured images in response to the heading direction sensor detecting that the motor vehicle is turning in a leftward direction, and the video signal is indicative of a mirror image of the area cropped from the captured images.

7. The arrangement of claim 1 wherein the rearview camera is mounted on a rear bumper of the motor vehicle.

8. A rearview display method for a motor vehicle, the method comprising:
capturing images of a scene behind the motor vehicle;
detecting a heading direction of the motor vehicle;
cropping an area from the captured images dependent upon the detected heading direction of the motor vehicle;
transmitting a video signal including the area cropped from the captured images; and
presenting the video signal to a driver of the motor vehicle.

9. The method of claim 8 wherein the detecting of the heading direction of the motor vehicle is performed by at least one of a steering wheel angle sensor, a speedometer, a gear sensor, and/or a gyroscope.

10. The method of claim 8 further comprising cropping an upwardly offset area from the captured images in response to detecting that the heading direction of the motor vehicle is moving upwardly toward the horizon.

11. The method of claim 8 further comprising cropping a downwardly offset area from the captured images in response to detecting that the heading direction of the motor vehicle is moving downwardly toward the horizon.

12. The method of claim 8 further comprising cropping a leftwardly offset area from the captured images in response to detecting that the motor vehicle is turning in a rightward direction, the video signal being indicative of a mirror image of the area cropped from the captured images.

13. The method of claim 8 further comprising cropping a rightwardly offset area from the captured images in response to the heading direction sensor detecting that the motor vehicle is turning in a leftward direction, the video signal being indicative of a mirror image of the area cropped from the captured images.

14. The method of claim 8 further comprising mounting the rearview camera on a rear bumper of the motor vehicle.

15. A rearview display arrangement for a motor vehicle, the arrangement comprising:
a rearview camera positioned to capture images of a scene behind the motor vehicle;
a plurality of heading direction sensors configured to conjunctively detect a heading direction of the motor vehicle in three dimensions;
an electronic processor communicatively coupled to the rearview camera and to the heading direction sensors, the electronic processor being configured to:
select an area to be cropped from the captured images dependent upon the detected heading direction of the motor vehicle; and
transmit a signal indicative of the area to cropped from the captured images; and
a rearview display screen communicatively coupled to the electronic processor and configured to:
receive the transmitted signal; and
present mirror images of the cropped captured images to a driver of the motor vehicle.

16. The arrangement of claim 15 wherein the heading direction sensors comprise a steering wheel angle sensor and a gyroscope.

17. The arrangement of claim 15 wherein the electronic processor is configured to crop an upwardly- and leftwardly-offset area from the captured images in response to the heading direction sensor detecting that the motor vehicle has reached a bottom of a hill and is turning in a rightward direction.

18. The arrangement of claim 15 wherein the electronic processor is configured to crop a downwardly- and leftwardly-offset area from the captured images in response to the heading direction sensor detecting that the motor vehicle has reached a top of a hill and is turning in a rightward direction.

19. The arrangement of claim 15 wherein the electronic processor is configured to crop an upwardly- and rightwardly-offset area from the captured images in response to the heading direction sensor detecting that the motor vehicle has reached a bottom of a hill and turning in a leftward direction.

20. The arrangement of claim 15 wherein the electronic processor is configured to crop a downwardly- and rightwardly offset area from the captured images in response to the heading direction sensor detecting that the motor vehicle has reached a top of a hill and is turning in a leftward direction.
